(19) United States
(12) Patent Application Publication
(10) Pub. No.: US 2002/0089632 A1
(43) Pub. Date: Jul. 11, 2002

(54) Liquid crystal display with a low driving voltage

(76) Inventor: Jia-Fam Wong, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,482

(22) Filed: Jan. 7, 2002

(30) Foreign Application Priority Data
Jan. 8, 2001 (TW) 090100379

(51) Int. Cl. G02F 1/1343

(52) U.S. Cl. 349/143

(57) ABSTRACT

An LCD includes a first substrate having a first surface, and a second substrate having a second surface with a pixel region. The LCD further includes first and second electrodes. The second electrode has a first slit elongated along a first direction. In addition, a third electrode is formed above the second electrode, and a second slit elongated along the first direction is disposed on the third electrode. A plurality of anisotropic liquid crystal molecules with a negative dielectric constant are positioned between the first electrode and the third electrode. A first horizontal biased electric field is formed in the neighborhood of the second slit, the first horizontal biased electric field is perpendicular to the first direction, and the liquid crystal molecules are rotated to make the longitudinal axis of the liquid crystal molecules in the neighborhood of the second slit being in parallel to the first direction.

### BACKGROUND OF THE INVENTION

1. Field of the Invention

The present invention relates to a liquid crystal display (LCD), and more particularly, to an LCD having a wide viewing angle and a low driving voltage.

2. Description of the Prior Art

An LCD has the characteristics of having low power consumption and low radiation, and lighter weight for practical use. It has been widely used in the notebook computers and personal digital assistants (PDAs), and has gradually replaced the traditional CRT monitor. The incident light will produce different polarizationor refraction when the alignments of these liquid crystal molecules are different. The LCD utilizes the characteristics of the liquid crystal molecules to control the light transmittance and produce gorgeous images. However, the view angle of the conventional LCD is limited by the structure of the liquid crystal molecule and the optical character. Thus, it is necessary to develop a LCD with wider view angle.

Please refer to FIG. 1A and FIG. 1B. FIG. 1A is the schematic diagram of the twisted nematic (TN) liquid crystal display 10 in the bright state according to the prior art. FIG. 2 is the schematic diagram of the twisted nematic LCD 10 in the dark state according to the prior art. As shown in FIG. 1A, the TN-LCD 10 includes an upper substrate 12, a bottom substrate 14 in parallel and opposite to the upper substrate 12, an upper electrode 16 positioned on the upper substrate 12, a lower electrode 18 positioned on the lower substrate 14, two polarizers 20, 22 respectively positioned above the upper substrate 12 and the lower substrate 14, and a plurality of anisotropic liquid crystal molecules 24 with the positive dielectric constant filled in the space between the upper substrate 12 and the lower substrate 14. The polarized direction P1 of the polarizer 20 is parallel to the paper surface, and the polarized direction P2 of the polarizer 24 is perpendicular to the paper surface. The arrangements of the liquid crystal molecules 24 from the top to the bottom are changed from the direction parallel to the paper surface to the direction perpendicular to the paper surface.

As shown in FIG. 1A, when no voltage is applied between the upper electrode 16 and the lower electrode 18 of the LCD 10, the liquid crystal molecules 24 are not affected by any electric field, and are parallel to the polarizers 20, 22, respectively. A light(not shown) is entered from the bottom and polarized after passing through the polarizer 22. The direction of the polarized light is perpendicular to the paper surface, and the polarized light can pass through the lower substrate 14. Next, the polarized light follows the direction of the liquid crystal molecules 24 and the direction of the light is gradually changed from a direction perpendicular to the paper surface to a direction parallel to the paper surface. Finally, the polarized light can pass through the upper substrate and the bright state of the TN-LCD 10 is formed because the direction of the polarized light is parallel to the polarized direction of the polarizer 20.

As shown in FIG. 1B, an electric field 26 is produced between the upper substrate 12 and the lower substrate 14 when a voltage is applied between the upper electrode 16 and the lower electrode 18. The liquid crystal molecule 24 has a positive dielectric constants so the longitudinal axis of the liquid crystal molecules 24 align in parallel to the direction of the electric field 26, and also align perpendicular to the upper and lower substrates 12, 14. Thus, the direction of the light passed through these liquid crystal molecules is perpendicular to the polarizer 20 and no light can pass through the polarizer 20 so that the observer located above the upper substrate 12 is unable to see light. Therefore, the dark state of the TN-LCD 10 is formed.

Usually, there is a pre-tilt angle (not shown) formed between the liquid crystal molecules 24 and the upper substrate 12 or the lower substrate 14 for lowering the threshold voltage of the TN-LCD 10 and easily rotating the liquid crystal molecules 24 influenced by the electric field 26. However, the pre-tilt angle results in asymmetry of the liquid crystal molecules 24 and different light intensities under different view angle. Thus, the TN-LCD 10 has a limited view angle of display. In the TN-LCD 10, only a part of the liquid crystal molecules 24 located in the center space between the two substrates 12, 14 can rotate perpendicular to the substrates 12, 14. The other parts of the liquid crystal molecules will be at an angle to the substrates 12, 14 due to the adhesion force between the liquid crystal molecules 24 and the substrates 12, 14. Moreover, when the above mentioned pre-tilt angle effect is considered, the liquid crystal molecules 24 under dark state do not arrange so uniform according to FIG. 1B. The performance of the dark state is poor and the contrast of the LCD 10 is decreased. Furthermore, the view angle of the TN-LCD 10 is small, even the left view angle is different from the right view angle.

Many techniques for improving the viewing angle are disclosed. One of these techniques for the display is an In-Plane Switching mode (IPS) liquid crystal display, as shown in FIG. 2. The prior IPS-LCD 50 includes an upper substrate 52, a lower substrate 54 parallel and opposite to the upper substrate 52, an upper electrode 56 and a lower electrode 58 disposed above the lower substrate 54, one polarizer 53a disposed above the upper substrate 52 and another polarizer 53b disposed beneath the lower substrate 54, and a plurality of liquid crystal molecules 57 between the upper substrate 52 and the lower substrate 54. The liquid crystal molecules 57 are anisotropic liquid crystal and have a positive dielectric constant. The operating principle of the IPS-LCD 50 is disclosed in U.S. Pat. No. 6,094,250, and will not be described again. By using the conventional IPS-LCD, the viewing angle can be increased, but the threshold voltage of the display can't be effectively reduced. Furthermore, the upper electrode 56 and the lower electrode 58 are both opaque metal electrodes, and so the transmission quality is decreased and open ration of the LCD is also reduced.

### SUMMARY OF INVENTION

It is therefore a primary objective of the claimed invention to provide an IPS-LCD having a lower driving voltage.

The liquid crystal display (LCD) disclosed in the claimed invention includes a first substrate and a second substrate. The first substrate has a first surface, the second substrate has a second surface, the second surface is in parallel with and opposite to the first surface, and a pixel area is defined on the second surface. A first electrode is positioned on the first surface of the first substrate. A second electrode is disposed above the pixel region of the second substrate, and the second electrode includes a first slit elongated along a first direction. An isolation layer is disposed on the surface of the second substrate to cover the second electrode.

A third electrode is disposed on the isolation layer. The third electrode is positioned within the pixel region. A second slit is defined on the third electrode and elongated along the first direction. The first slit and the second slit is interlaced. A plurality of anisotropic liquid crystal molecules with negative dielectric constant are positioned between the first electrode and the third electrode. The longitudinal axis of the liquid crystal molecules is parallel to a second direction horizontally, and a first angle is formed between the first direction and the second direction.

A biased electric field is formed when a voltage is applied between the first electrode and the second electrode. In this time, a first horizontal biased electric field is formed in the neighborhood of the second slit. The first horizontal biased electric field is perpendicular to the first direction, and the liquid crystal molecules are rotated to make the longitudinal axis of the liquid crystal molecules in the neighborhood of the second slit being in parallel to the first direction.

In addition, the longitudinal axis of the liquid crystal molecules in the neighborhood of the first electrode maintain along the second direction because no horizontal biased electrical field is formed near the first electrode. The liquid crystal molecules between the first electrode and the second slit of the third electrode gradually rotate from the second direction to the first direction.

It is an advantage of the claimed invention that it provides a lower driving voltage so that power consumption is reduced.

These and other objectives and the advantages of the present invention will no doubt become obvious to those of ordinary skill in the art after having read the following detailed description of the preferred embodiment, which is illustrated in the various figures and drawings.

### BRIEF DESCRIPTION OF DRAWINGS

FIG. 1A is a diagram showing the bright state of a TN-LCD according to the prior art.

FIG. 1B is a diagram showing the dark state of a TN-LCD according to the prior art.

FIG. 2 is a diagram of an IPS mode LCD according to the prior art.

FIG. 3 is a diagram showing the structure of a LCD in the present invention.

FIGS. 4A to 4D are top views showing the slits and liquid crystal molecules in the present invention.

FIG. 5 is a sectional view of the first preferred embodiment shown in FIG. 3.

FIG. 6 is a sectional view of a second preferred embodiment of the present invention.

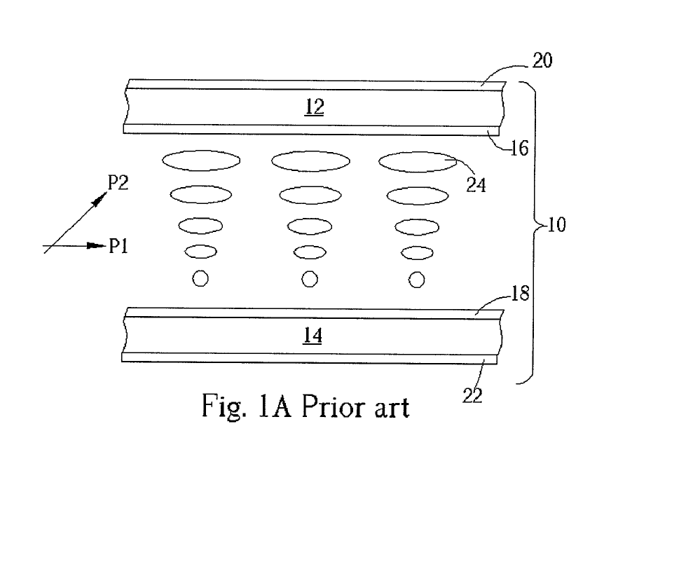

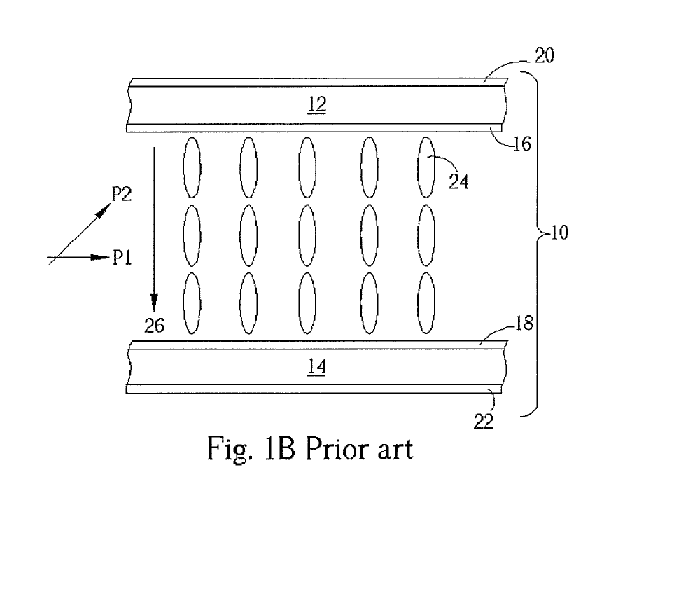

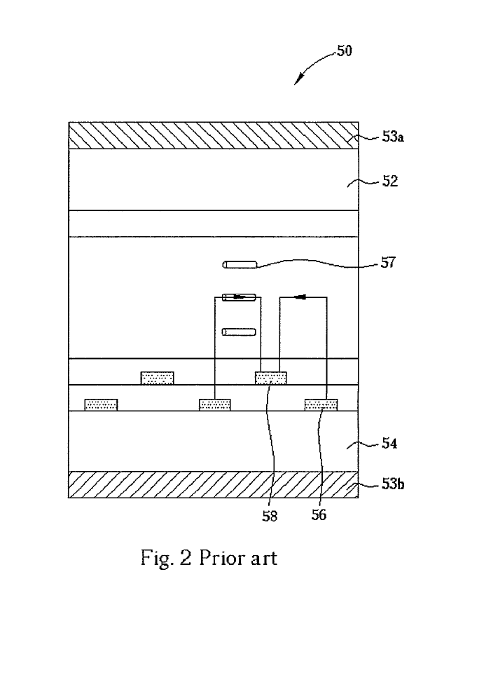

### DETAILED DESCRIPTION

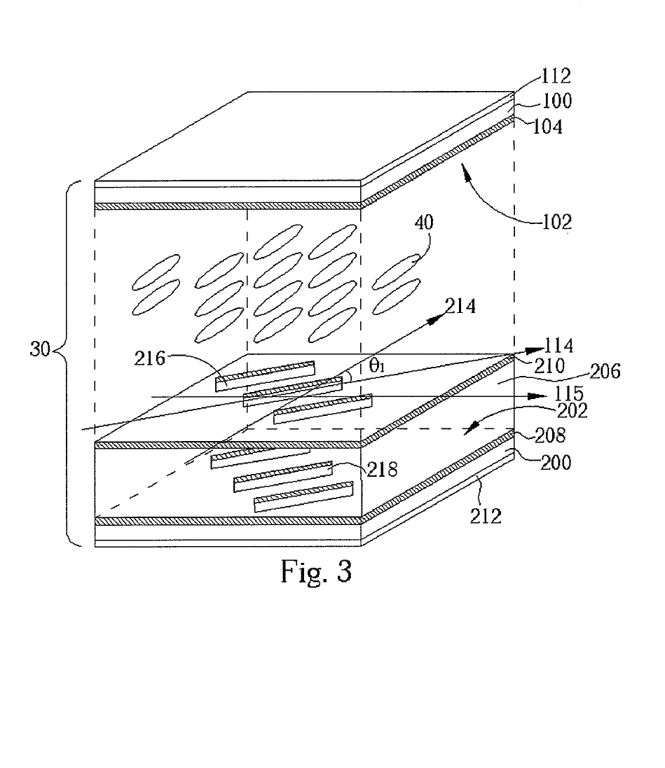

Please refer to FIG. 3. FIG. 3 is a diagram of a LCD 30 having a lower driving voltage in the present invention. As FIG. 3 shows, the LCD 30 has a first substrate 100 with a first surface 102, and a second substrate 200 with a second surface 202. The second substrate 200 has a pixel region (not shown), and the second surface 202 of the second substrate 200 is parallel and in opposite to the first surface 102 of the first substrate 100. The first substrate 100 can be an upper substrate or a lower substrate, and the second substrate 200 can be a corresponding lower or upper substrate. As shown in FIG. 3, a first electrode 104 is disposed on the first surface 102 of the first substrate, and a polarizer 112 is positioned on the other surface of the first substrate 100. The first electrode 104 is an upper common electrode and positioned on the first substrate 100. A second electrode 208 is disposed above the pixel region of the second substrate 200, and is used as a pixel electrode 208. An isolation layer 206 is disposed on the second electrode 208, and a third electrode 210 is disposed on the isolation layer 206. The third electrode 210 is also formed in the pixel region, and is served as a lower common electrode 210. The pixel electrode 208 has a first slit 218 elongated along a first direction 114. The common electrode 210 has a second slit 216 elongated along the first direction 114. The first and second slits are formed in an interlaced arrangement. The first electrode 104, the pixel electrode 208 and the lower common electrode 210 can be made of a transparent conductive material, for increasing the transmission and the aperture ratio of the LCD. Additionally, a polarizer 212 is positioned below the second substrate 200.

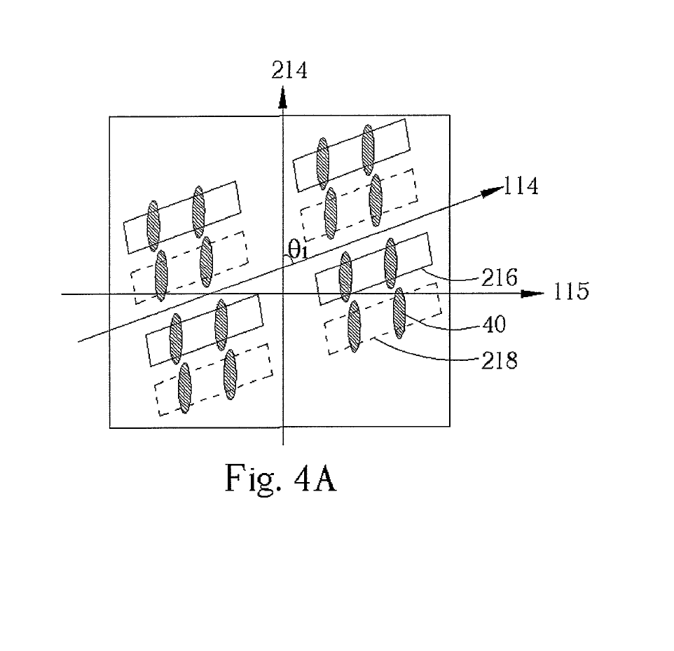

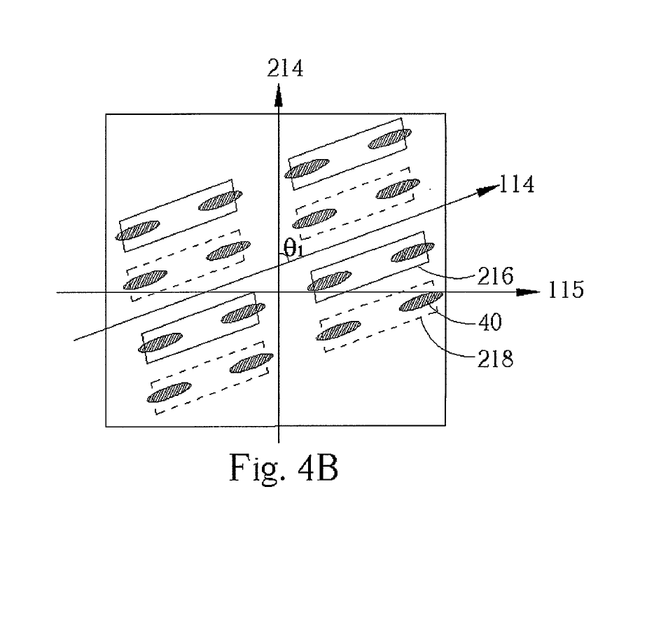

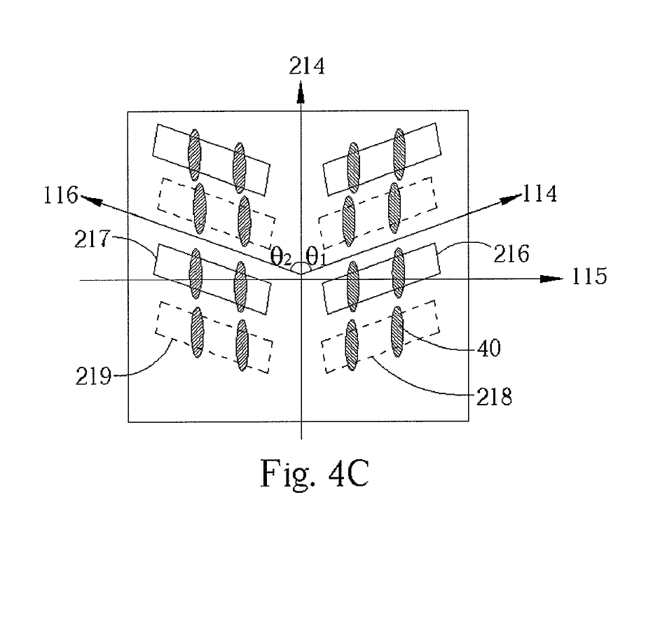

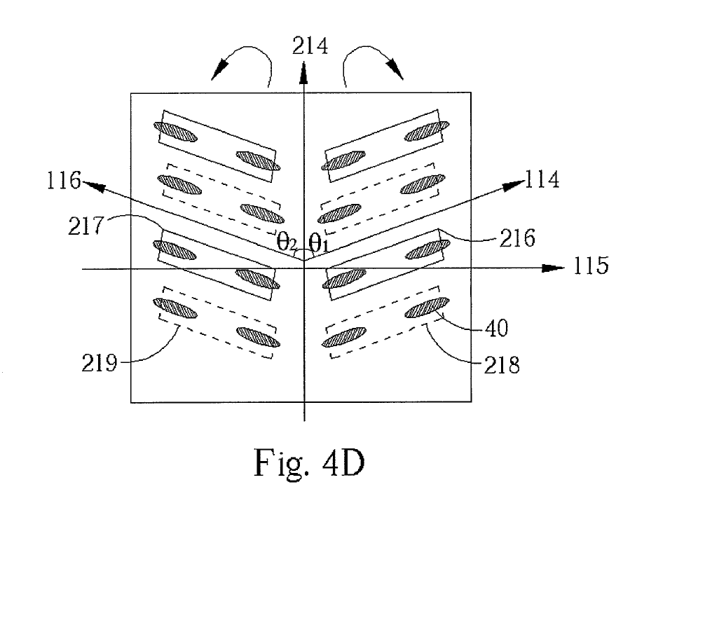

Please refer to FIG. 4A and FIG. 4B which are top views of FIG. 3. As shown in FIG. 4A, a plurality of first slits 218 elongated along the first direction 114 are formed on the pixel electrode 208, and a plurality of second slits 216 are, also elongated along the first direction 114, formed on the common electrode 210. A plurality of anisotropic liquid crystal molecules 40, with a negative dielectric constant, are formed between the first electrode 104 and the lower common electrode 210.

While no voltage is applied to liquid crystal display, the longitudinal axis of the liquid crystal molecules 40 are parallel to a second direction, and a first angle θ₁ is formed between the first direction 114 and the second direction 214. The second direction 214 is the polarized direction 214 of the polarizer 212, and another polarized direction of the polarizer 112 is a third direction 115. The third direction 115 is perpendicular to the second direction 214. Furthermore, a switch (not shown) is positioned on the first substrate 100 or the second substrate 200 to control the operation of the LCD 30.

As shown in FIG. 4A, the switch is not turned on, and no voltage exists to generate an electric field between the first electrode 104 and the pixel electrode 208. In this time, the liquid crystal molecules 40 are aligned to the second direction 214 and perpendicular to the polarized direction 115 of the polarizer 112. The incident light thus cannot pass through the polarizer 112, and so the user can see no image on the LCD 30. The LCD 30 is in a perfect “dark state” when no electric field exists. Referring to FIG. 4B, the switch is turned on, the liquid crystal molecules 40 are affected by the electric field and gradually turn to the first direction 114 from the second direction 214. The LCD 30 is in the “bright state” and images can be shown on the LCD 30.

Please refer to FIG. 4C and FIG. 4D, which are top views showing other types of slits. As shown in FIG. 4C, these first slits 218 and second slits, elongated along the first direction 114, are disposed on the pixel electrode 208 and the lower common electrode 210, respectively. These third slits 219 and fourth slits, elongated along a fourth direction 116, are disposed above the pixel electrode 208 and the lower common electrode 210, respectively. When no effective electric field is occurred, the longitudinal axis of the liquid crystal molecules 40 aligns in parallel to the second direction 214. A first angle θ₁ is formed between the first direction 114 and the second direction 214, and a second angle θ₂ is formed between the fourth direction 116 and the second direction 214. When the switch is turned on and an electric field is occurred, as shown in FIG. 4D, the liquid crystal molecules will be influenced by the electric field and turn to align with the first direction 114 or the fourth direction 116. Therefore, the LCD 30 is in the bright state for showing images.

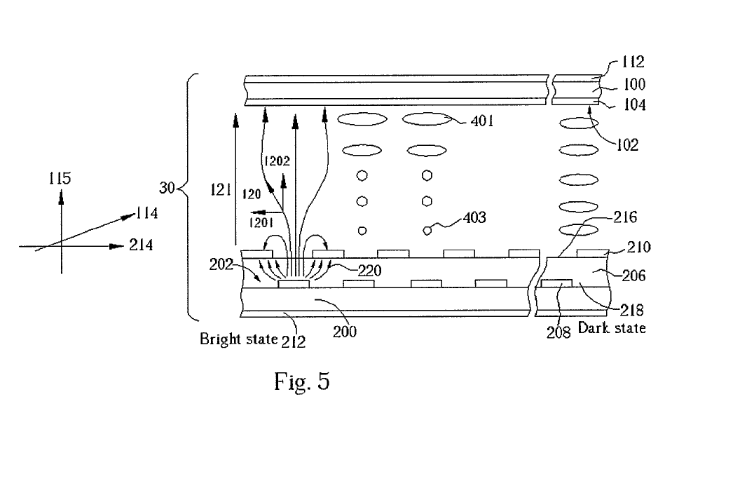

Please refer to FIG. 5. FIG. 5 is a sectional view of FIG. 3 along the second direction 214. When a switch is turned on, a voltage is provided between the first electrode 104 and the pixel electrode 208. The first electrode 104 and the lower common electrode 210 have an equal voltage level, so that a biased electric field 120 is formed between the first electrode 104 and the pixel electrode 208, and another biased electric field 220 is formed between the lower common electrode 210 and the pixel electrode 208. A first horizontal biased electric field 1201 is formed in the neighborhood of the second slit 216 of the lower common electrode 210. The first horizontal biased electric field 1201 is perpendicular to the first direction 114. The negative liquid crystal molecules 40 tend to be in perpendicular to the electric field so the liquid crystal molecules rotate. Therefore, after applying the voltage, the longitudinal axis of the liquid crystal molecules 403 near the second slit 216 of the lower common electrode 210 will gradually rotate from the second direction 214 to the first direction 114. Furthermore, a vertical biased electric field 1202 is also formed near the second slit 216 of the lower common electrode 210, the vertical biased electric field 1202 is perpendicular to the surface of the second substrate 200. The vertical biased electric field 1202 is also perpendicular to the longitudinal axis of the liquid crystal molecules 40, and maintains the liquid crystal molecules 40 to rotate on a fixed plane.

Moreover, the longitudinal axis of the liquid crystal molecules in the neighborhood of the first electrode 104 remain to align to the second direction 214 because no horizontal biased electrical field is formed near the first electrode 104. These liquid crystal molecules between the first electrode 104 and the second slit 216 of the lower common electrode 210 gradually rotate from the second direction 214 to the first direction 114. A bright state, similar to the bright state of the conventional TN-LCD without applied voltage, is then formed. After the liquid crystal molecules 403 are rotated, the incident lights pass through the polarizer 212. The liquid crystal molecules rotate gradually from the second direction 214 to the first direction 114, and so as the incident lights do. The incident lights can pass the polarizer 112 finally, and this is the bright state of the LCD 30 in the present invention.

In other words, the biased electric field 120 produces a vertical biased electric field 1202 and a horizontal biased electric field 1201 between the first substrate 100 and the second substrate 200. The vertical biased electric field 1202 is perpendicular to the first direction 114 and will keep the liquid crystal molecules 403 rotating on the fixed plane. The horizontal biased electric field 1201 triggers for gradually rotating that the liquid crystal molecules 40 near the second slit 216 of the lower common electrode 210. Further, another biased electric field 220 is formed to strengthen the horizontal biased electric field 1201 so as to accelerate the rotation of the liquid crystal molecules 403.

In the embodiment, a lower common electrode 210 is provided to strengthen the horizontal electric field so as to drive the liquid crystal molecules 403 near slits easily. The response speed of the liquid crystal molecules is increased so the driving voltage of the LCD 30 can be reduced. Second, the isolation layer 206 is used to isolate the lower common electrode 210 and the pixel electrode 208 so as to avoid short circuits between the pixel electrode 208 and the first electrode 104. Furthermore, the first electrode 104, the pixel electrode 208 and the lower common electrode 210 are made of transparent conductive materials so that the transmission of the LCD 30 is increased. When the driving voltage is reduced, the widths of the pixel electrode 208 and the lower common electrode 210 can be reduced, and the aperture ratio of the LCD 30 is increased.

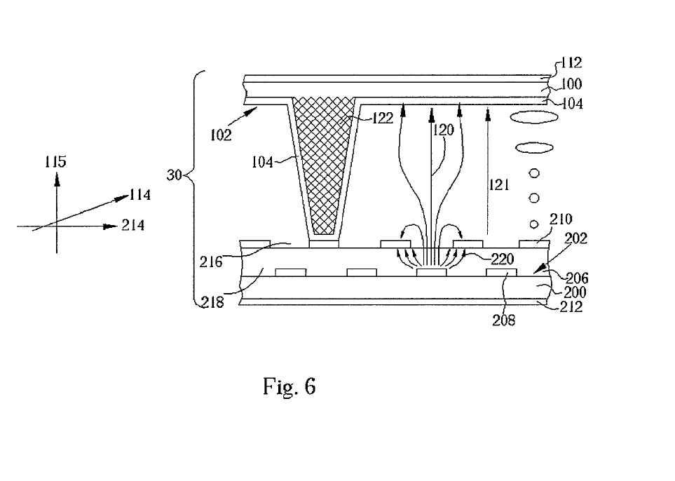

Please refer to FIG. 6. FIG. 6 is a sectional view of a second embodiment of LCD 30 in the present invention. The first substrate 100 of the first embodiment as shown in FIG. 3 to FIG. 5 is a flat plate. There are a plurality of protrusions formed on the first surface 102 of the first substrate 100 of the second embodiment. As shown in FIG. 6, these protrusions 122 are disposed within a region of a data line, and the first electrode 104 is disposed above the first substrate 100 and cover these protrusions 122. The first electrode 104 will contact the lower common electrode 210, and has an equal voltage with the lower common electrode 210.

The advantage of the second embodiment is that a smaller voltage can be applied between the first electrode 104 and the pixel electrode 208 when the first electrode 104 is in contact with the lower common electrode 210. The problem about a common signal delay can be reduced when the common signal is applied in the first electrode. The width of the signal line (not shown) and the lower common electrode 210 can be reduced when the driving voltage is smaller, so that the aperture ratio of the LCD is increased. Additionally, the static charges accumulated on the upper electrode 104 can be released when the first electrode 104 is in contact with the lower common electrode. A strengthened electric field 220 is formed between the pixel electrode 208 and the lower common electrode 210 because the distance between the pixel electrode 208 and the lower common electrode 210 is smaller. This electric field 220 can speed up the rotation of the liquid crystal molecules 403 to form the bright state of the LCD 30 and reduce the signal delay.

In the second embodiment, the protrusions are also used to adjust a cell gap between the first substrate 100 and the second substrate 200. The cell gap can be controlled in a range because a lot of protrusions are formed between these substrates 100, 200. Therefore, ripples of the display image and light leakage problem of the LCD, caused by ball shape spacers in the prior arts, can be eliminated.

Compared to a conventional IPS mode LCD, the power consumption of LCD 30 is reduced because of a lower driving voltage in the present invention. The line widths of the data line and the lower common electrode 210 can be reduced when the first electrode 104 contacts the lower common electrode 210. The area occupied by these data lines is smaller, and the aperture ration of the LCD is increased. A LCD with a high driving speed and an increased image quality are achieved. Furthermore, the isolation layer of the present invention can prevents electrodes from short-circuiting, thus eliminating problems of bright spots on a LCD.

The above disclosure is not intended to be limiting. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A liquid crystal display (LCD) comprising:
a first substrate comprising a first surface;
a second substrate comprising a second surface, the second surface being in parallel with and opposite to the first surface of the first substrate, and a pixel area being defined on the second surface;
a first electrode positioned on the first surface of the first substrate;
a second electrode disposed above the pixel region of the second substrate, the
second electrode having a first slit elongated along a first direction;
an isolation layer disposed on the surface of the second substrate to cover the second electrode;
a third electrode disposed on the isolation layer and within the pixel region, a second slit being defined on the third electrode and along the first direction, the first and second silts being interlaced; and
a plurality of anisotropic liquid crystal molecules with negative dielectric constant positioned between the first electrode and the third electrode, the longitudinal axis of the liquid crystal molecules being positioned along a second direction horizontally, and a first angle being formed between the first direction and the second direction;
wherein a biased electric field is formed as a voltage is applied between the first electrode and the second electrode,
such that (a) a first horizontal biased electric field is formed in the neighborhood of the second slit, the first horizontal biased electric field is perpendicular to the first direction, and the liquid crystal molecules are rotated to make the longitudinal axis of the liquid crystal molecules in the neighborhood of the second slit being in parallel to the first direction,
(b) the longitudinal axis of the liquid crystal molecules in the neighborhood of the first electrode maintain along the second direction because no horizontal biased electrical field is formed near the first electrode, and
(c) the liquid crystal molecules between the first electrode and the second slit of the third electrode gradually rotate from the second direction to the first direction.

2. The liquid crystal display of claim 1, further comprising a first polarizer positioned above the first substrate, and a second polarizer positioned below the second substrate.

3. The liquid crystal display of claim 1 wherein the second electrode is a transparent pixel electrode.

4. The liquid crystal display of claim 1 wherein the third electrode is a transparent lower common electrode.

5. The liquid crystal display of claim 1 wherein the biased electric field formed between the second electrode and the third electrode is used to accelerate the rotation of the liquid crystal molecules so as to reduce a driving voltage of the liquid crystal display.

6. The liquid crystal display of claim 1 wherein the isolation layer is used to isolate the second electrode from the third electrode and avoid a short circuit between the second electrode and the third electrode.

7. The liquid crystal display of claim 1 further comprising a protrusion projected from the first surface of the first substrate, the protrusion being electrically connecting the first electrode with the third electrode so that the first electrode and the third electrode being in a substantially equal voltage.

8. The liquid crystal display of claim 7 wherein a common signal is provided to the first and third electrodes, the first electrode is connected to the third electrode so as to reduce a delay of the common signal.

9. The liquid crystal display of claim 7 wherein the third electrode has a width, and the width is reduced when the first electrode is connected to the third electrode so as to increase an aperture ratio of the display.

10. The liquid crystal display of claim 7 wherein static charges formed on the first electrode are released through the protrusion after the first electrode is connected to the third electrode.

11. The liquid crystal display of claim 7 wherein the distance between the first and second substrate is defined as a cell gap, and the protrusion is used to form an even cell gap between the first and second substrates.
